(19) United States
(12) Patent Application Publication
(10) Pub. No.: US 2023/0131310 A1
(43) Pub. Date: Apr. 27, 2023

(54) SWITCHING SYSTEM OF EDR WATER PURIFIER WITH THREE-WAY SOLENOID VALVE

(71) Applicants: CHING-HSIUNG LIN, PINGTUNG CITY (TW); KEMFLO (NANJING) ENVIRONMENTAL TECHNOLOGY CO., LTD., NANJING (CN); KEMFLO INTERNATIONAL CO., LTD., PINGTUNG CITY (TW)

(72) Inventors: ALLEN DING, NANJING (CN); EDISON FAN, NANJING (CN)

(21) Appl. No.: 17/540,518

(22) Filed: Dec. 2, 2021

(30) Foreign Application Priority Data
Oct. 26, 2021 (CN) 202111247534.0

(51) Int. Cl. B01D 61/52; B01D 61/54; C02F 1/469; G05D 7/06; B01D 61/46

(52) U.S. Cl. CPC B01D 61/52; B01D 61/54; C02F 1/4695; G05D 7/0652; B01D 61/46; B01D 2313/18; C02F 2201/005

(57) ABSTRACT

A switching system of an EDR water purifier has a first inlet end, a second inlet end, a first three-way solenoid valve, a second three-way solenoid valve, a third three-way solenoid valve, a fourth three-way solenoid valve, an EDR membrane stack, a first outlet end, and a second outlet end. The EDR membrane stack has a first inlet port, a second inlet port, a first outlet port, a second outlet port, a first electrode, and a second electrode. Each three-way solenoid valve has an inlet opening, a first outlet opening, and a second outlet opening. Each outlet opening of each three-way solenoid valve can be turned open or closed for switching two water routes passing the EDR membrane stack. Therefore, speed of forming limescale decreases, lifespan of the EDR membrane stack is prolonged, and water-purifying efficiency is improved.

### BACKGROUND OF THE INVENTION

### 1. Field of the Invention

The present invention relates to a switching system of a water purifier, and more particularly to a switching system of an electrodialysis reversal (EDR) water purifier.

### 2. Description of Related Art

With continuous improvement of life quality, most families have water purifiers in their houses to assure healthy drinking water. However, one-way operation of an EDR membrane stack of a conventional EDR water purifier in the long run leads to accumulation of ions in a concentrated water tank and precipitated limescale. As a result, functions of the EDR membrane stack of the conventional EDR water purifier tend to decay dramatically. Also, because a first electrode of the EDR membrane stack is lastingly charged positively, and a second electrode of the EDR membrane stack is lastingly charged negatively, lifespans of the EDR membrane stack and the two electrodes thereof are shortened, and efficiency of the conventional EDR water purifier decreases.

To solve this problem, workers used to wash the EDR membrane stack along with a cathode and an anode thereof to reduce total dissolved solids (TDS) in the EDR membrane stack, while this way not only causes waste of water, but is also time-consuming and labor-intensive.

In view of this, an improved solution to the aforementioned problem is desired by the industry.

### SUMMARY OF THE INVENTION

The main objective of the present invention is to provide a switching system of an EDR water purifier to solve the aforementioned problem, wherein two inlet ends and two outlet ends of the EDR water purifier do not have to be changed. By switching two water routes that pass through an EDR membrane stack, switching of a purified water branch and a concentrated water branch is achieved. By reversing polarity of electric currents, exchanging of polarity of two electrodes of the EDR membrane stack is achieved. In this way, forming of limescale on a surface of the EDR water membrane stack is effectively alleviated, lifespans of the EDR membrane stack and the electrodes thereof are extended, and water-purifying efficiency of the EDR membrane stack is improved.

The switching system of the EDR water purifier has a first inlet end, a second inlet end, a first three-way solenoid valve, a second three-way solenoid valve, a third three-way solenoid valve, a fourth three-way solenoid valve, an electrodialysis reversal (EDR) membrane stack, a first outlet end, and a second outlet end. The EDR membrane stack has a first inlet port, a second inlet port, a first outlet port, a second outlet port, a first electrode, and a second electrode. Each one of the first three-way solenoid valve, the second three-way solenoid valve, the third three-way solenoid valve, and the fourth three-way solenoid valve has an inlet opening, a first outlet opening, and a second outlet opening. The first inlet end is connected to the inlet opening of the first three-way solenoid valve, and the second inlet end is connected to the inlet opening of the second three-way solenoid valve. The first outlet port of the EDR membrane stack is connected to the inlet opening of the third three-way solenoid valve, and the second outlet port of the EDR membrane stack is connected to the inlet opening of the fourth three-way solenoid valve. The first inlet port of the EDR membrane stack is connected to one of the first outlet opening and the second outlet opening of the first three-way solenoid valve and one of the first outlet opening and the second outlet opening of the second three-way solenoid valve, and the second inlet port of the EDR membrane stack is connected to the other one of the first outlet opening and the second outlet opening of the first three-way solenoid valve and the other one of the first outlet opening and the second outlet opening of the second three-way solenoid valve, so water routes communicating with the first inlet port are switchable and water routes communicating with the second inlet port are switchable.

The first outlet end is connected to one of the first outlet opening and the second outlet opening of the third three-way solenoid valve and one of the first outlet opening and the second outlet opening of the fourth three-way solenoid valve, and the second outlet end is connected to the other one of the first outlet opening and the second outlet opening of the third three-way solenoid valve and the other one of the first outlet opening and the second outlet opening of the fourth three-way solenoid valve, so water routes communicating with the first outlet end are switchable and water routes communicating with the second outlet end are switchable.

The first outlet opening and the second outlet opening of each one of the first three-way solenoid valve, the second three-way solenoid valve, the third three-way solenoid valve, and the fourth three-way solenoid valve are configured to be turned either open or closed such that two water routes passing through the EDR membrane stack are switchable, polarity of the first electrode and the second electrode is exchangeable by reversing polarity of electric currents applied on the first electrode and the second electrode.

Furthermore, the switching system comprises a communication state and a switched state. In the communication state, the first outlet opening of the first three-way solenoid valve is closed, the second outlet opening of the first three-way solenoid valve is open and communicates with the first inlet port of the EDR membrane stack, the first outlet opening of the second three-way solenoid valve is closed, the second outlet opening of the second three-way solenoid valve is open and communicates with the second inlet port of the EDR membrane stack, the first outlet opening of the third three-way solenoid valve is closed, the second outlet opening of the third three-way solenoid valve is open and communicates with the first outlet end, the first outlet opening of the fourth three-way solenoid valve is closed, and the second outlet opening of the fourth three-way solenoid valve is open and communicates with the second outlet end.

In the switched state, the second outlet opening of the first three-way solenoid valve is closed, and the first outlet opening of the first three-way solenoid valve is open and communicates with the second inlet port of the EDR membrane stack, the second outlet opening of the second three-way solenoid valve is closed, the first outlet opening of the second three-way solenoid valve is open and communicates with the first inlet port of the EDR membrane stack, the second outlet opening of the third three-way solenoid valve is closed, the first outlet opening of the third three-way solenoid valve is open and communicates with the second outlet end, the second outlet opening of the fourth three-way solenoid valve is closed, the first outlet opening of the fourth three-way solenoid valve is open and communicates with the first outlet end, and the polarity of the first electrode and the second electrode is exchanged by reversing the polarity of the electric currents applied on the first electrode and the second electrode.

Furthermore, the switching system comprises an electronic control device. The electronic control device is configured to control each one of the first outlet opening and the second outlet opening of the first three-way solenoid valve, the second three-way solenoid valve, the third three-way solenoid valve, and the fourth three-way solenoid valve to turn open or closed, and to control exchanging of the polarity of the first electrode and the second electrode.

Moreover, the switching system comprises multiple check valves. The check valves are each disposed in a respective one of the following positions: between the first outlet opening of the first three-way solenoid valve and the second inlet port of the EDR membrane stack, between the second outlet opening of the first three-way solenoid valve and the first inlet port of the EDR membrane stack, between the first outlet opening of the second three-way solenoid valve and the first inlet port of the EDR membrane stack, between the second outlet opening of the second three-way solenoid valve and the second inlet port of the EDR membrane stack, between the first outlet opening of the third three-way solenoid valve and the second outlet end, between the second outlet opening of the third three-way solenoid valve and the first outlet end, between the first outlet opening of the fourth three-way solenoid valve and the first outlet end, and between the second outlet opening of the fourth three-way solenoid valve and the second outlet end.

A working principle of the present invention is: because inlet water routes and outlet water routes connected on two sides of the EDR membrane stack each have a respective one of the four three-way solenoid valves thereon, the switching system in practice may control which one of the two outlet openings of each three-way solenoid valve to turn open and the other to turn closed, so as to switch the two water routes passing through the EDR membrane stack, i.e. switch the purified water branch and the concentrated water branch. Also, by reversing the polarity of the electric currents applied on the two electrodes, the polarity of the two electrodes is exchanged.

The switching system of the EDR water purifier can effectively alleviate forming of limescale on the surface of the EDR membrane stack, extend the lifespans of the EDR membrane stack and the electrodes, and improve water-purifying efficiency of the EDR membrane stack.

### BRIEF DESCRIPTION OF THE DRAWINGS

FIG. 1 is a hydraulic schematic diagram of a switching system of an EDR water purifier in accordance with the present invention;

FIG. 2 is an operational hydraulic schematic diagram of the switching system of the EDR water purifier in FIG. 1, showing a communication state; and

FIG. 3 is another operational hydraulic schematic diagram of the switching system of the EDR water purifier in FIG. 1, showing a switched state.

### DETAILED DESCRIPTION OF THE PREFERRED EMBODIMENT

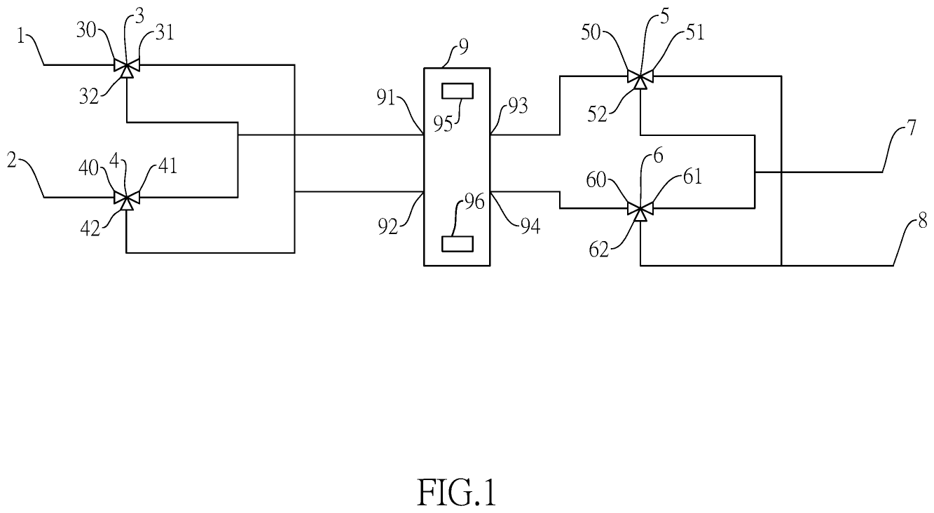

With reference to FIG. 1, a switching system of an electrodialysis reversal (EDR) water purifier comprises a first inlet end 1, a second inlet end 2, a first three-way solenoid valve 3, a second three-way solenoid valve 4, a third three-way solenoid valve 5, a fourth three-way solenoid valve 6, an EDR membrane stack 9, a first outlet end 7, and a second outlet end 8.

The EDR membrane stack 9 has a first inlet port 91, a second inlet port 92, a first outlet port 93, a second outlet port 94, a first electrode 95, and a second electrode 96. Each one of the first three-way solenoid valve 3, the second three-way solenoid valve 4, the third three-way solenoid valve 5, and the fourth three-way solenoid valve 6 has an inlet opening 30, 40, 50, 60, a first outlet opening 31, 41, 51, 61, and a second outlet opening 32, 42, 52, 62. The first inlet end 1 is connected to the inlet opening 30 of the first three-way solenoid valve 3, and the second inlet end 2 is connected to the inlet opening 40 of the second three-way solenoid valve 4. The first outlet port 93 of the EDR membrane stack 9 is connected to the inlet opening 50 of the third three-way solenoid valve 5, and the second outlet port 94 of the EDR membrane stack 9 is connected to the inlet opening 60 of the fourth three-way solenoid valve 6.

The first inlet port 91 of the EDR membrane stack 9 is connected to one of the first outlet opening 31 and the second outlet opening 32 of the first three-way solenoid valve 3 and one of the first outlet opening 41 and the second outlet opening 42 of the second three-way solenoid valve 4, and the second inlet port 92 of the EDR membrane stack 9 is connected to the other one of the first outlet opening 31 and the second outlet opening 32 of the first three-way solenoid valve 3 and the other one of the first outlet opening 41 and the second outlet opening 42 of the second three-way solenoid valve 4, so water routes communicating with the first inlet port 91 are switchable and water routes communicating with the second inlet port 92 are switchable.

The first outlet end 7 is connected to one of the first outlet opening 51 and the second outlet opening 52 of the third three-way solenoid valve 5 and one of the first outlet opening 61 and the second outlet opening 62 of the fourth three-way solenoid valve 6, and the second outlet end 8 is connected to the other one of the first outlet opening 51 and the second outlet opening 52 of the third three-way solenoid valve 5 and the other one of the first outlet opening 61 and the second outlet opening 62 of the fourth three-way solenoid valve 6, so water routes communicating with the first outlet end 7 are switchable and water routes communicating with the second outlet end 8 are switchable.

The first outlet opening 31, 41, 51, 61 and the second outlet opening 32, 42, 52, 62 of each one of the first three-way solenoid valve 3, the second three-way solenoid valve 4, the third three-way solenoid valve 5, and the fourth three-way solenoid valve 6 are configured to be turned either open or closed such that two water routes passing through the EDR membrane stack 9 are switchable, and polarity of the first electrode 95 and the second electrode 96 is exchangeable by reversing polarity of electric currents applied on the first electrode 95 and the second electrode 96.

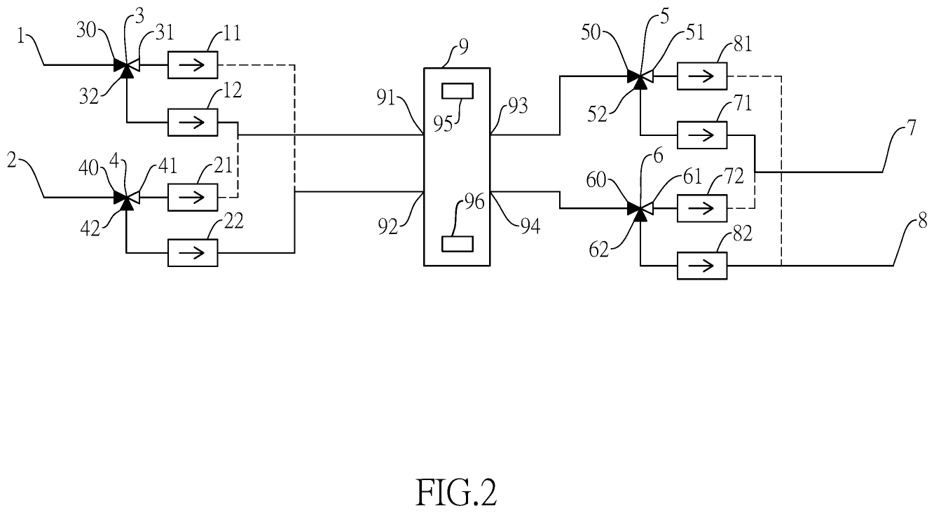

With reference to FIG. 2, in the communication state, the first electrode 95 is positively charged, and the second electrode 96 is negatively charged. The first outlet opening 31 of the first three-way solenoid valve 3 is closed, and the second outlet opening 32 of the same is open and communicates with a respective check valve 12 and the first inlet port 91 of the EDR membrane stack 9. The first outlet opening 41 of the second three-way solenoid valve 4 is closed, and the second outlet opening 42 of the same is open and communicates with a respective check valve 22 and the second inlet port 92 of the EDR membrane stack 9. The first outlet opening 51 of the third three-way solenoid valve 5 is closed, and the second outlet opening 52 of the same is open and communicates with a respective check valve 71 and the first outlet end 7. The first outlet opening 61 of the fourth three-way solenoid valve 6 is closed, and the second outlet opening 62 of the same is open and communicates with a respective check valve 82 and the second outlet end 8.

In this way, unpurified water flows into the first inlet port 91 of the EDR membrane stack 9 from the first inlet end 1 through the first three-way solenoid valve 3 and the corresponding check valve 12. After processed by the EDR membrane stack 9, processed water flows through the first outlet port 93, the third three way solenoid valve 5, and the corresponding check valve 71, and flows out from the first outlet end 7. Unpurified water also flows into the second inlet port 92 of the EDR membrane stack 9 from the second inlet end 2 through the second three-way solenoid valve 4 and the corresponding check valve 22. After processed by the EDR membrane stack 9, processed water flows through the second outlet port 94, the fourth three way solenoid valve 6, and the corresponding check valve 82, and flows out from the second outlet end 8.

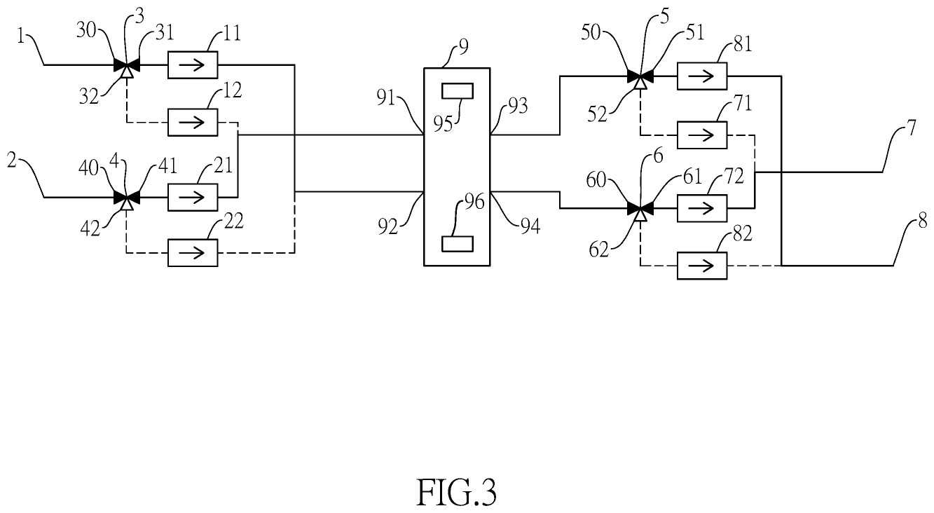

While in the switched state, with reference to FIG. 3, the first electrode 95 is negatively charged, and the second electrode 96 is positively charged. The second outlet opening 32 of the first three-way solenoid valve 3 is closed, and the first outlet opening 31 of the same is open and communicates with a respective check valve 11 and the second inlet port 92 of the EDR membrane stack 9. The second outlet opening 42 of the second three-way solenoid valve 4 is closed, and the first outlet opening 41 of the same is open and communicates with a respective check valve 21 and the first inlet port 91 of the EDR membrane stack 9. The second outlet opening 52 of the third three-way solenoid valve 5 is closed, and the first outlet opening 51 of the same is open and communicates with a respective check valve 81 and the second outlet end 8. The second outlet opening 62 of the fourth three-way solenoid valve 6 is closed, and the first outlet opening 61 of the same is open and communicates with a respective check valve 72 and the first outlet end 7.

In this way, unpurified water flows into the second inlet port 92 of the EDR membrane stack 9 from the first inlet end 1 through the first three-way solenoid valve 3 and the corresponding check valve 11. After processed by the EDR membrane stack 9, processed water flows through the second outlet import 94, the fourth three-way solenoid valve 6, the corresponding check valve 72, and flows out from the first outlet end 7. Unpurified water also flows into the first inlet port 91 of the EDR membrane stack 9 from the second inlet end 2 through the second three-way solenoid valve 4 and the corresponding check valve 21. After processed by the EDR membrane stack 9, processed water flows through the first outlet port 93, the third three-way solenoid valve 5, the corresponding check valve 81 and the second outlet end 8.

Thus, by switching between the communication state and the switched state, the two routes passing through the EDR membrane stack 9 are switched, so the purified water branch and the concentrated water branch are consequently switched. Also, by reversing the polarity of electric currents applied to the two electrodes 95, 96, exchanging of polarity of the two electrodes 95, 96 of the EDR membrane stack 9 is achieved. As a result, forming of limescale on a surface of the EDR water membrane stack 9 is effectively alleviated, lifespans of the EDR membrane stack 9 and the electrodes 95, 96 thereof are extended, and water-purifying efficiency of the EDR membrane stack 9 is improved.

Besides, the switching system of the EDR water purifier further comprises an electronic control device. The electronic control device is configured to control each one of the outlet openings 31, 32, 41, 42, 51, 52, 61, 62 of the four three-way solenoid valves 30, 40, 50, 60 to turn open or closed, and to control reversing of the polarity of electric currents applied to the two electrodes 95, 96 and hence fulfills exchanging of the polarity of the two electrodes 95, 96. For instance, after a specific time of use, the electronic control device turns one of the two outlet openings 31, 32, 41, 42, 51, 52, 61, 62 of each one of the four three-way solenoid valves 30, 40, 50, 60 open, and turns the other outlet opening 31, 32, 41, 42, 51, 52, 61, 62 of each three-way solenoid valve 30, 40, 50, 60 closed simultaneously. Further, the polarity of electric currents applied to the two electrodes 95, 96 is also reversed. Therefore, the state of the polarity of electric currents and the state of communication can be switched.

The above-mentioned description elaborates the embodiment of the present invention; however, it shall not constitute restrictions on claims of the present invention. Without departing from the technical means of the present invention, a person having ordinary skill in the art may make some changes and improvements thereto, and those changes and improvements fall within the protection scope of the present invention. Thus the protection scope of the present invention depends on the claims of the present invention.

Furthermore, the aforementioned embodiment and the specific technical features thereof may be reassembled in any reasonable way as long as no conflicting features take place. To avoid unnecessary repetitive description, other possible assembling methods are omitted.

What is claimed is:

1. A switching system of an electrodialysis reversal (EDR) water purifier, and the switching system comprising a first inlet end, a second inlet end, a first three-way solenoid valve, a second three-way solenoid valve, a third three-way solenoid valve, a fourth three-way solenoid valve, an EDR membrane stack, a first outlet end, and a second outlet end; wherein
the EDR membrane stack comprises a first inlet port, a second inlet port, a first outlet port, a second outlet port, a first electrode, and a second electrode;
each one of the first three-way solenoid valve, the second three-way solenoid valve, the third three-way solenoid valve, and the fourth three-way solenoid valve comprises an inlet opening, a first outlet opening, and a second outlet opening;
the first inlet end is connected to the inlet opening of the first three-way solenoid valve, and the second inlet end is connected to the inlet opening of the second three-way solenoid valve;
the first outlet port of the EDR membrane stack is connected to the inlet opening of the third three-way solenoid valve, and the second outlet port of the EDR membrane stack is connected to the inlet opening of the fourth three-way solenoid valve;
the first inlet port of the EDR membrane stack is connected to one of the first outlet opening and the second outlet opening of the first three-way solenoid valve and one of the first outlet opening and the second outlet opening of the second three-way solenoid valve, and the second inlet port of the EDR membrane stack is connected to the other one of the first outlet opening and the second outlet opening of the first three-way solenoid valve and the other one of the first outlet opening and the second outlet opening of the second three-way solenoid valve, so water routes communicating with the first inlet port are switchable and water routes communicating with the second inlet port are switchable;
the first outlet end is connected to one of the first outlet opening and the second outlet opening of the third three-way solenoid valve and one of the first outlet opening and the second outlet opening of the fourth three-way solenoid valve, and the second outlet end is connected to the other one of the first outlet opening and the second outlet opening of the third three-way solenoid valve and the other one of the first outlet opening and the second outlet opening of the fourth three-way solenoid valve, so water routes communicating with the first outlet end are switchable and water routes communicating with the second outlet end are switchable; and
the first outlet opening and the second outlet opening of each one of the first three-way solenoid valve, the second three-way solenoid valve, the third three-way solenoid valve, and the fourth three-way solenoid valve are configured to be turned either open or closed such that two water routes passing through the EDR membrane stack are switchable, polarity of the first electrode and the second electrode is exchangeable by reversing polarity of electric currents applied on the first electrode and the second electrode.

2. The switching system of the EDR water purifier as claimed in claim 1, wherein
the switching system comprises a communication state and a switched state;
in the communication state, the first outlet opening of the first three-way solenoid valve is closed, the second outlet opening of the first three-way solenoid valve is open and communicates with the first inlet port of the EDR membrane stack, the first outlet opening of the second three-way solenoid valve is closed, the second outlet opening of the second three-way solenoid valve is open and communicates with the second inlet port of the EDR membrane stack, the first outlet opening of the third three-way solenoid valve is closed, the second outlet opening of the third three-way solenoid valve is open and communicates with the first outlet end, the first outlet opening of the fourth three-way solenoid valve is closed, and the second outlet opening of the fourth three-way solenoid valve is open and communicates with the second outlet end; and
in the switched state, the second outlet opening of the first three-way solenoid valve is closed, and the first outlet opening of the first three-way solenoid valve is open and communicates with the second inlet port of the EDR membrane stack, the second outlet opening of the second three-way solenoid valve is closed, the first outlet opening of the second three-way solenoid valve is open and communicates with the first inlet port of the EDR membrane stack, the second outlet opening of the third three-way solenoid valve is closed, the first outlet opening of the third three-way solenoid valve is open and communicates with the second outlet end, the second outlet opening of the fourth three-way solenoid valve is closed, the first outlet opening of the fourth three-way solenoid valve is open and communicates with the first outlet end, and the polarity of the first electrode and the second electrode is exchanged by reversing the polarity of the electric currents applied on the first electrode and the second electrode.

3. The switching system of the EDR water purifier as claimed in claim 1, wherein
the switching system comprises an electronic control device; and
the electronic control device is configured to control each one of the first outlet opening and the second outlet opening of the first three-way solenoid valve, the second three-way solenoid valve, the third three-way solenoid valve, and the fourth three-way solenoid valve to turn open or closed, and to control exchanging of the polarity of the first electrode and the second electrode.

4. The switching system of the EDR water purifier as claimed in claim 2, wherein
the switching system comprises multiple check valves;
the check valves are each disposed in a respective one of the following positions:
between the first outlet opening of the first three-way solenoid valve and the second inlet port of the EDR membrane stack;
between the second outlet opening of the first three-way solenoid valve and the first inlet port of the EDR membrane stack;
between the first outlet opening of the second three-way solenoid valve and the first inlet port of the EDR membrane stack;
between the second outlet opening of the second three-way solenoid valve and the second inlet port of the EDR membrane stack;
between the first outlet opening of the third three-way solenoid valve and the second outlet end;
between the second outlet opening of the third three-way solenoid valve and the first outlet end;
between the first outlet opening of the fourth three-way solenoid valve and the first outlet end; and
between the second outlet opening of the fourth three-way solenoid valve and the second outlet end.

5. The switching system of the EDR water purifier as claimed in claim 3, wherein
the switching system comprises multiple check valves;
the check valves are each disposed in a respective one of the following positions:
between the first outlet opening of the first three-way solenoid valve and the second inlet port of the EDR membrane stack;
between the second outlet opening of the first three-way solenoid valve and the first inlet port of the EDR membrane stack;
between the first outlet opening of the second three-way solenoid valve and the first inlet port of the EDR membrane stack;
between the second outlet opening of the second three-way solenoid valve and the second inlet port of the EDR membrane stack;
between the first outlet opening of the third three-way solenoid valve and the second outlet end;
between the second outlet opening of the third three-way solenoid valve and the first outlet end;
between the first outlet opening of the fourth three-way solenoid valve and the first outlet end; and
between the second outlet opening of the fourth three-way solenoid valve and the second outlet end.
